(19) United States
(12) Patent Application Publication
(10) Pub. No.: US 2012/0018573 A1
(43) Pub. Date: Jan. 26, 2012

(54) COMPACT SHIMMY DAMPER FOR AIRCRAFT LANDING GEAR

(76) Inventors: David J. Jones, Gloucester (GB); Royston Alan Evans, Gloucestershire (GB)

(21) Appl. No.: 13/166,424

(22) Filed: Jun. 22, 2011

(30) Foreign Application Priority Data
Jul. 21, 2010 (GB) 1012255.4

(51) Int. Cl. B64C 25/50; B23P 11/00; B64C 25/58

(52) U.S. Cl. 244/50; 244/104 FP; 29/428

(57) ABSTRACT

A shimmy damper for aircraft landing gear is provided. The shimmy damper comprises a housing, a rotor with a vane provided within the housing, and first and second fluid chambers, connected by a control orifice and separated from one another by the vane.

### BACKGROUND OF THE INVENTION

1. Field of the Invention

The present disclosure relates generally to dampers for reducing shimmy in aircraft landing gear. More particularly, the present disclosure relates to a compact shimmy damper for aircraft landing gear that may be used with an electrically-driven aircraft landing gear steering system.

2. Description of Related Art

Mechanical dampers are known and commonly used for many applications. However, the cantilevered landing gear type fitted to most aircraft are prone to shimmy oscillations during take-off and landing rolls. These oscillations result from a combination of lateral and longitudinal forces acting at the contact patch of the tires on a runway surface and can be initiated by several means, such as, for example, one or more tires being out of balance, impacts with objects, excessive clearances in bearings/joints, etc.

In conventional aircraft systems, the shimmy oscillations are normally damped out by means of control orifices within hydraulically operated actuators that are used to provide steering inputs to the landing gear. Alternatively, separate dedicated hydraulic shimmy dampers or damping systems may be provided externally to the main landing gear structure.

However, increased progress towards use of electrically operated aircraft with the adoption of electrical actuation for steering systems means that such a solution is no longer optimal. Additionally, since dampers need to continue to function if electrical power is lost, use of any fully-powered active damping systems would thus be unlikely to meet strict aviation certification requirements.

Nevertheless, although various passive shimmy dampers for aircraft steering systems are known, they still suffer from various drawbacks, such as, for example they may be mechanically complex, heavy, have a low in-service operational lifetime and/or be inherently unsuitable for use in anything other than light aircraft.

### BRIEF SUMMARY OF THE INVENTION

In view of the above, there is provided a shimmy damper for aircraft landing gear, wherein the shimmy damper comprises: a housing, a rotor with a vane provided within the housing, and a first and a second fluid chambers connected by a control orifice and separated from one another by the vane.

According to another aspect, there is provided a steerable landing gear wheel train unit for an aircraft, comprising a shimmy damper wherein the shimmy damper comprises: a housing, a rotor with a vane provided within the housing, and a first and a second fluid chambers connected by a control orifice and separated from one another by the vane.

According to a further aspect, there is provided a method of fitting a shimmy damper to an aircraft landing gear, wherein the shimmy damper comprises: a housing, a rotor with a vane provided within the housing, and a first and a second fluid chambers connected by a control orifice and separated from one another by the vane.

Further aspects, advantages and features of the embodiments of the present invention are apparent from the dependent claims, the description and the accompanying drawings.

An advantage of various aspects and embodiments of the present invention is the enabling of removal or reduction of various hydraulic systems and components with an associated weight reduction and operational reliability enhancement.

### BRIEF DESCRIPTION OF THE SEVERAL VIEWS OF THE DRAWINGS

A full and enabling disclosure including the best mode thereof, to one of ordinary skill in the art, is set forth more particularly in the remainder of the specification, including reference to the accompanying figures wherein:

FIG. 1 shows a vertical cross-section through an aircraft landing gear oleo in accordance with an embodiment of the present invention;

FIG. 2 shows a horizontal cross-section through a shimmy damper in accordance with an embodiment of the present invention; and

FIG. 3 shows a vertical cross-section through a shimmy damper in accordance with an embodiment of the present invention.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations

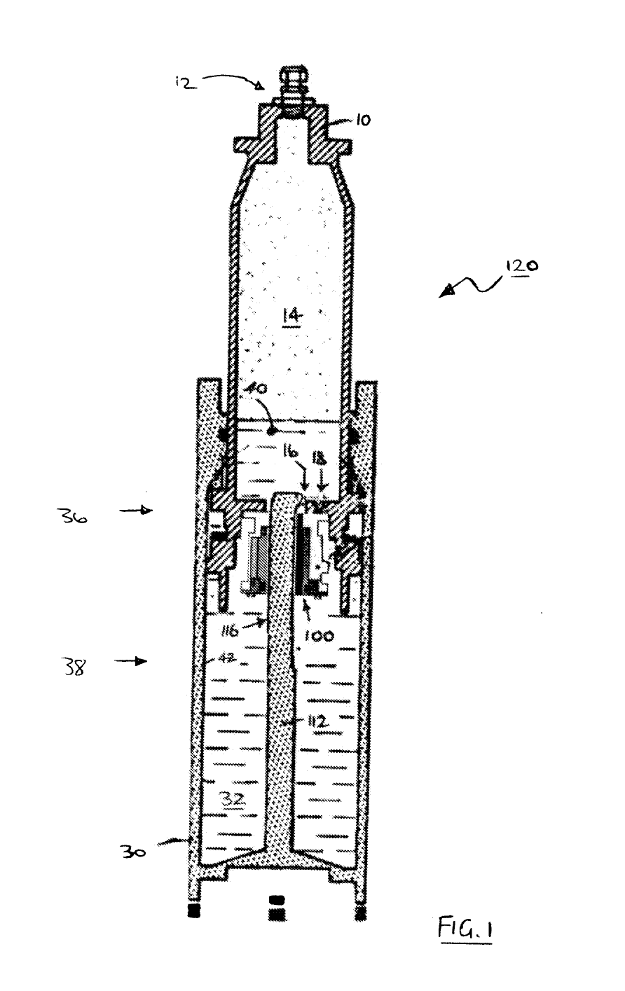

FIG. 1 shows an aircraft landing gear oleo 120 in accordance with an embodiment of the present invention. The landing gear oleo 120 comprises an oleo piston 10 that is slidably mounted in an oleo leg 30. The oleo piston 10 can be connected to an aircraft fuselage (not shown) by way of a connector arrangement 12. A landing gear train (not shown) may be connected to the oleo leg 30. In various embodiments, the oleo piston 10 and the oleo leg 30 can be rotated with respect to each other to provide a steerable landing gear train. Such steering may, for example, be provided using a motor actuated electrically-driven system.

Oleo piston 10 includes a piston chamber 14. The piston chamber 14 may be filled with inert gas, such as for example, nitrogen (N₂). Oleo leg 30 has an axially central slide bearing mount 112 having an upper hexagonally-shaped guide shaft portion 116, although various other non-circular shapes may also be used. Between the slide bearing mount 112 and an inner wall 42 of the oleo leg 30 a hydraulic fluid chamber 32 is defined. Hydraulic fluid 40 is sealed within the landing gear oleo 120 and in use fills the hydraulic fluid chamber 32.

In use, the landing gear oleo 120 is orientated towards the ground when the landing gear train is in its operational down and locked position. The hydraulic fluid 40 thus pools in the hydraulic fluid chamber 32 whilst the fill gas collects in an upper part of the piston chamber 14 proximal to the connector arrangement 12. Radially spaced first and second channels 16, 18 are provided in a lower portion of the oleo piston 10 to allow the hydraulic fluid 40 to flow between the hydraulic fluid chamber 32 and the piston chamber 14. The first channel 16 provides a variable cross section depending upon the position of a variable diameter actuator shaft (not shown) passing through it so as to provide increased damping near to extreme ends of travel. The second channel 18 has a fixed cross sectional area. Fluid flow between the hydraulic fluid chamber 32 and the piston chamber 14 provides a longitudinal damping action when the landing gear oleo 120 is compressed in an axial direction.

The inner wall 42 of the oleo leg 30 and lower portion of the oleo piston 10 are shaped to cooperate so as to provide stop positions when the oleo piston 10 is at an upper fully extended position 36 and a lower fully compressed position 38. The stop positions enable the landing gear oleo 120 to operate between these two extreme positions 36, 38 and prevent damage thereto by either over-extension or over-compression.

A shimmy damper 100 is also provided within the landing gear oleo 120. A housing of the shimmy damper 100 is fixed to the lower portion of the oleo piston 10 in the vicinity of the first and second channels 16, 18. Additionally, the shimmy damper 100 is coaxially disposed in keyed engagement about the guide shaft portion 116 such that it is free to move in a longitudinal axial direction with the oleo piston 10, but so that any relative rotational motion between the oleo leg 30 and the oleo piston 10 causes the guide shaft portion 116 to drive the shimmy damper 100.

In the illustrated embodiment, the landing gear oleo 120 is a sealed unit and the shimmy damper 100 fills with hydraulic fluid 40 from the hydraulic fluid chamber 32 of the landing gear oleo 120. Thus no separate or external hydraulic fluid supplies are needed for the shimmy damper 100 to operate.

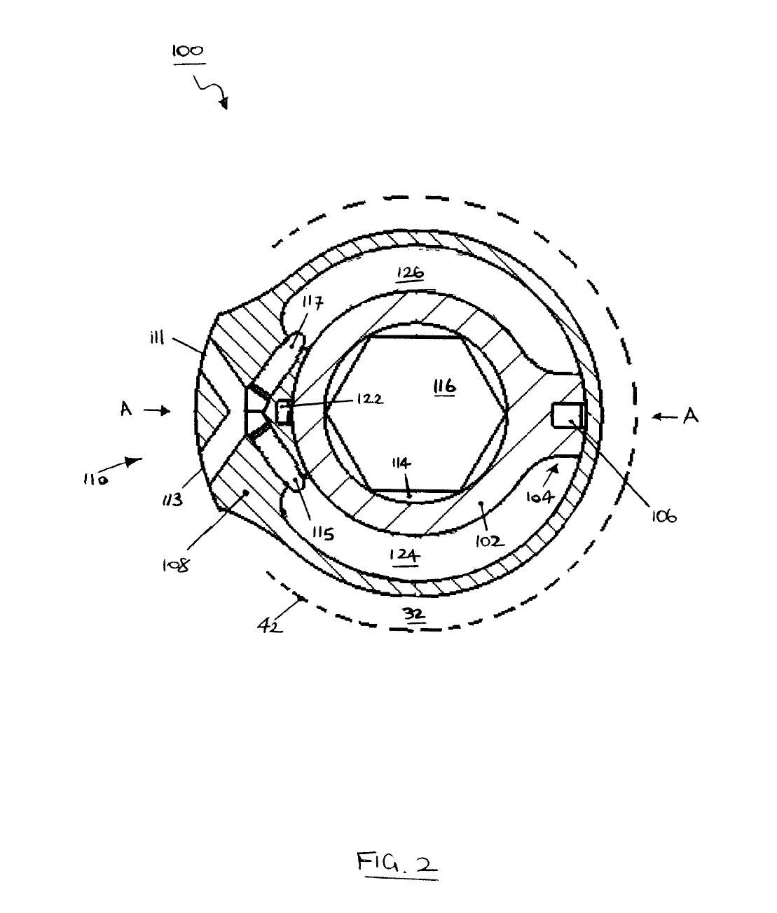

FIG. 2 shows a horizontal cross-section through a shimmy damper 100 in accordance with an embodiment of the present invention. The shimmy damper 100 is for use in aircraft landing gear. For example, the shimmy damper 100 may be used in the landing gear oleo 120 shown in FIG. 1. Such a shimmy damper 100 is both compact and operationally reliable.

The shimmy damper 100 comprises a housing 108, a rotor 102 with a vane 104 provided within the housing 108, and first and second fluid chambers 124, 126 connected by a control orifice 110. The first and second fluid chambers 124, 126 are also separated from one another by the vane 104 and can be filled with hydraulic fluid 40. The vane 104 is preferably provided with a seal groove 106 and an elastomeric seal provided in the seal groove 106 to help separate the first and second fluid chambers 124, 126. A rotor seal 122 bearing onto the rotor 102 is also provided adjacent to the control orifice 110 within the housing 108.

The hydraulic fluid 40 may be provided in an aircraft landing gear oleo 120, or could be provided from a separate shimmy damper specific reservoir. Where a conventional oleo hydraulic fluid supply is used, various embodiments of the present invention provide the advantages that a separate hydraulic fluid supply and its associated reservoirs, pipes, etc. are not needed with consequent weight and reliability improvements being obtained.

In the illustrated embodiment, diametrically opposed portions of the rotor 102 are used to form a part of respective first and second fluid chambers 124, 126 such that the hydraulic fluid 40 is housed between the housing 108, the rotor 102 and the vane 104 in two fluid chambers. However, those skilled in the art would be aware that extended portions of the housing 108 also could be used to partially define such fluid chambers.

The control orifice 110 has a first passage 111 and a second passage 113 coupled to a hydraulic fluid reservoir. For example, as shown in outline schematically in FIG. 2, such a hydraulic fluid reservoir may be provided by a hydraulic fluid chamber 32 defined at least in part by the inner wall 42 of an oleo leg.

The first passage 111 and the second passage 113 are further connected to the first fluid chamber 124 by a first one way restrictor 115 and to the second fluid chamber 126 by a second one way restrictor 117. Such one way restrictors 115, 117 may be provided using standard conventional non-return valves, and these enable the shimmy damper 100 to be self-filling once installed. This is advantageous as it makes such a shimmy damper 100 easier to manufacture, transport and install.

The first passage 111, the second passage 113 and the first and second one way restrictors 115, 117 together define a substantially X-shaped channel through which hydraulic fluid 40 can flow from the first fluid chamber 124 though the channel and into the second fluid chamber 126, and vice-versa. The diameter of the channel of this embodiment is fixed. However, in various alternative embodiments a variable cross-section channel can be provided, for example, by using a servo valve. This enables optimisation of damping performance over a wide range of input parameters whilst also maintaining sufficient control in the event of a total power loss.

Concentrically mounted within the rotor 102 is a slide bearing interface 114 which forms part of a slide bearing 118. The slide bearing interface 114 may be provided as a separate component or may be formed integrally with the rotor 102. The slide bearing interface 114 has a hexagonally-shaped bore in which a hexagonally-shaped guide shaft portion 116 may be provided. The cooperating hexagonal shapes help prevent slippage between the rotor 102, to which the slide bearing interface 114 is fixed, and any guide shaft portion 116 provided in the bore. Any shimmy oscillations on the guide shaft portion 116 are also transmitted to the shimmy damper through the slide bearing 118.

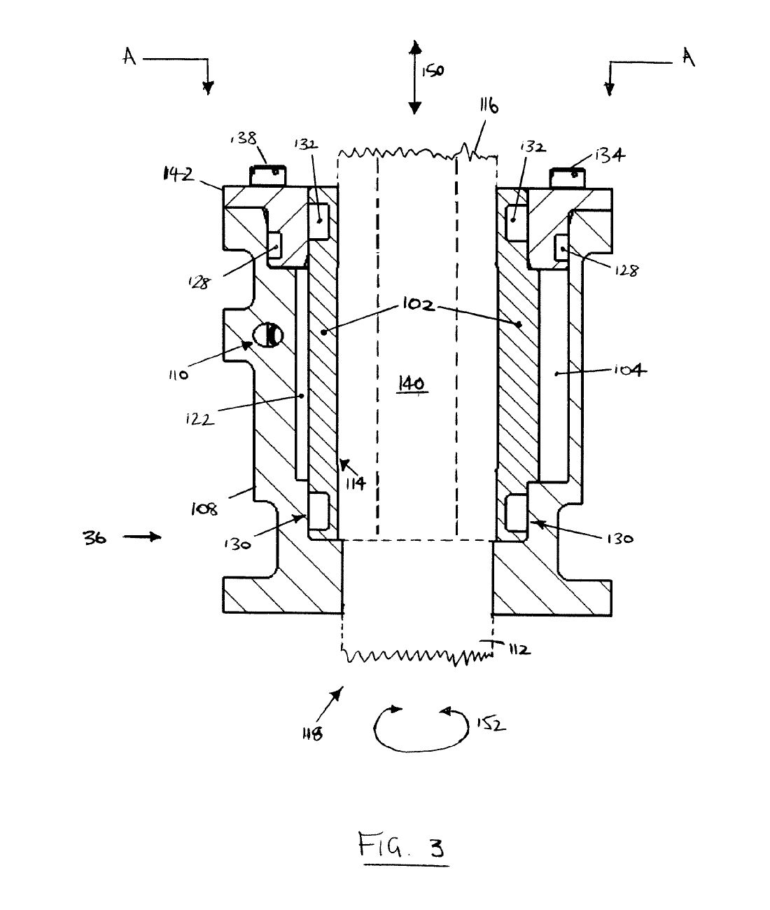

FIG. 3 shows a vertical cross-section through the shimmy damper 100 of FIG. 2 along the line A-A. Note that the shimmy damper 100 is depicted in an inverted position with respect to that shown in FIG. 1.

The rotor 102 (which may, for example, be made from an aluminium-bronze alloy material) is inserted into a cavity 140 formed in the housing 108. A lower portion of the rotor 102 is provided with a first annular rotary seal 130 that forms a fluid-tight seal between the rotor 102 and the housing 108.

An annular housing coupling flange 142 is provided to retain the rotor 102 within the cavity 140. The housing coupling flange 142 is secured to the housing 108 using bolts 134, 138. Although only two such bolts 134, 138 are shown, those skilled in the art will realise that more such bolts may be used. The housing coupling flange 142 is provided with an annular static seal 128 about a neck portion thereof The static seal 128 provides a fluid-tight seal between the housing coupling flange 142 and an upper portion of the housing 108.

An upper portion of the rotor 102 is provided with a second annular rotary seal 132 that forms a fluid-tight seal between the rotor 102 and the housing coupling flange 142. The first and second fluid chambers 124, 126 are thus isolated from the cavity 140 to prevent hydraulic fluid leakage.

A slide bearing 118 is formed between the slide bearing interface 114 and a guide shaft portion 116 when inserted therein. The guide shaft portion 116 is thereby able to move freely within the cavity 140 relative to the shimmy damper 100 in a longitudinal direction 150.

This enables sliding landing gear parts to move relative to the shimmy damper 100 substantially unimpeded in a direction substantially parallel to the central axis thereof (e.g. in a vertical direction with respect to an aircraft, when installed therein).

However, any rotation (e.g. in the direction of arrows 152) with respect to the shimmy damper 100 of sliding landing gear parts connected through the slide bearing 118 will cause the rotor 102 to rotate within the housing 108 forcing fluid from one of the fluid chambers 124, 126 to the other via the control orifice 110. This forced fluid movement provides a damping force to any shimmy-induced oscillations.

Various aspects and embodiments of the present invention have been described herein. However, those skilled in the art will be aware that many different embodiments of shimmy dampers are possible.

For example, one advantage of various aspects and embodiments of the present invention is the enabling of removal or reduction of various hydraulic systems and components with an associated weight reduction and operational reliability enhancement. In certain embodiments, except for dampers elements in the oleos of certain aircraft landing gear, use of various external fluid pipe connections may be avoided thus enabling weight reduction whilst providing a reduced risk of, possibly corrosive, hydraulic fluid leakage.

Various embodiments of the present invention may be provided, for example, in a concentrically-mounted arrangement within landing gear components, such as an oleo. Those skilled in the art would be aware that such arrangements could be provided by, for example, joining part of a shimmy damper housing to landing gear oleo parts such that rotation therebetween is substantially eliminated, by using one or more of: welding, bolting, riveting, keying in with mutually cooperating/inter-engaging non-circular cross-sectional profiles, etc.

Advantageously, various embodiments of the present invention may also be provided by retro-fitting a shimmy damper in accordance with various embodiments of the present invention to existing aircraft landing gear parts. For example, an outer surface of a housing may be shaped to conform to an inner surface of the landing gear oleo to provide respective inner and outer cooperating surface shapes that are non-cylindrical, such that a keyed fit is provided between the housing and the landing gear oleo in order to prevent relative rotational motion therebetween.

Moreover, as shown herein, various aspects and embodiments of the present invention can be provided in which relative longitudinal motion of parts is enabled whilst any rotational oscillations therebetween are damped.

This written description uses examples, including the best mode, to enable any person skilled in the art to make and use the described subject-matter. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope is defined by the claims, and may include such modifications and other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A shimmy damper for aircraft landing gear, the shimmy damper comprising:
a housing;
a rotor with a vane provided within the housing; and
first and second fluid chambers connected by a control orifice and separated from one another by the vane.

2. The shimmy damper of claim 1, wherein the control orifice has a fixed cross-section channel.

3. The shimmy damper of claim 1, wherein the control orifice has a variable cross-section channel.

4. The shimmy damper of claim 3, wherein the variable cross-section channel is provided by one or more servo valves.

5. The shimmy damper of claim 1, wherein the control orifice further comprises one or more one-way restrictor valves.

6. The shimmy damper of claim 1, further comprising at least one slide bearing for enabling landing gear parts to move in a substantially parallel relationship to one another without any significant damping action therebetween.

7. A steerable landing gear wheel train unit for an aircraft, the steerable landing gear wheel train unit comprising a shimmy damper fitted within a landing gear oleo, wherein the shimmy damper comprises:
a housing;
a rotor with a vane provided within the housing; and
first and second fluid chambers connected by a control orifice and separated from one another by the vane.

8. The steerable landing gear wheel train unit of claim 7, wherein hydraulic fluid in the landing gear oleo is used to supply the shimmy damper.

9. The steerable landing gear wheel train unit of claim 7, wherein the housing is shaped to fit within the landing gear oleo such that rotation therebetween is substantially eliminated.

10. A method of fitting a shimmy damper to aircraft landing gear, the shimmy damper comprising a housing, a rotor with a vane provided within the housing, first and second fluid chambers connected by a control orifice and separated from one another by the vane, the method comprising:
providing the shimmy damper such that it lies wholly within a landing gear oleo.

11. The method of claim 10, further comprising:
shaping an internal surface of the landing gear oleo to conform to an outer surface of the housing of the shimmy damper; and
fixing the shimmy damper within the landing gear oleo such that the shimmy damper lies wholly therein.
